(19) United States
(12) Patent Application Publication
(10) Pub. No.: US 2025/0321167 A1
(43) Pub. Date: Oct. 16, 2025

(54) LIQUID SPECIMEN LYSIS DETECTION DEVICE

(71) Applicant: Hangzhou Alltest Biotech Co.,Ltd, Hangzhou (CN)

(72) Inventors: Jiufa Lin, Hangzhou (CN); Yinfei Wu, Hangzhou (CN); Haipeng Hu, Hangzhou (CN); Cunbang Zheng, Hangzhou (CN); Xiaocheng Wu, Hangzhou (CN); Jinshu Chen, Hangzhou (CN); Weike Lu, Hangzhou (CN)

(21) Appl. No.: 19/171,906

(22) Filed: Apr. 7, 2025

(30) Foreign Application Priority Data
Apr. 10, 2024 (CN) 202420734620.7

(51) Int. Cl. G01N 1/38; B01L 3/00

(52) U.S. Cl. CPC G01N 1/38; B01L 3/5023; B01L 3/502715; B01L 2200/027; B01L 2200/16; B01L 2300/044; B01L 2300/0672; B01L 2300/069

(57) ABSTRACT

The disclosure discloses a liquid specimen lysis detection device. The device includes a detection unit, a lysis unit and a detachable limit structure, where the detection unit includes a detection shell, a sample acquisition unit and a detection reagent strip, the lysis unit includes a base, a piercing sleeve, a sealing film and a bottom bottle. The detachable limit structure is installed between the detection unit and the lysis unit to limit the depth of the detection unit inserted into the top opening of the base in the initial state, so as to prevent the piercing sleeve from piercing the sealing film. In the detection state, the detachable limit structure is removed, and the piercing sleeve pierces the sealing film under the push of the plug-in section of the detection shell; the sample acquisition unit extends into the bottom bottle.

### CROSS-REFERENCE TO RELATED APPLICATIONS

This application claims priority to Chinese Patent Application No. 202420734620.7, filed on Apr. 10, 2024, the contents of which are hereby incorporated by reference.

### TECHNICAL FIELD

The disclosure belongs to the technical field of liquid specimen detection, and in particular to a liquid specimen lysis detection device.

### BACKGROUND

In the prior art, when liquid specimens such as saliva are not lysed using a lysis solution, the limited saliva volume from certain individuals may fail to meet the required amount for testing, thereby affecting the test results. When a lysis solution is employed, the saliva must first be mixed with the solution before being added to the testing device. This process is relatively complex and increases the risk of sample contamination during transfer.

In the patent with the publication number CN220194900U, titled “An Integrated Device for Collection, Storage, and Detection of Body Fluid Samples,” a device capable of integrating lysis and detection is provided. However, it requires a bottle structure for storing reagent strips, resulting in a relatively large overall size. Moreover, during the detection process, the liquid specimen needs to be squeezed out from the sample absorbent body. In this process, the sample absorbent body is prone to significant residual liquid, leading to waste of the liquid specimen.

### SUMMARY

The disclosure aims to provide a liquid specimen lysis detection device.

The disclosure provides a liquid specimen lysis detection device, including a sampling detection unit, a lysis unit and a detachable limit structure. The sampling detection unit includes a detection shell, a sample acquisition unit and a detection reagent strip. The detection reagent strip is installed on the detection shell. The detection shell is divided into a holding section and a plug-in section. The end of the plug-in section is provided with an opening. The sample acquisition unit is fixed at the opening of the detection shell. The sample acquisition unit is in contact with the sample loading zone of the detection reagent strip.

The lysis unit includes a base, a piercing sleeve, a sealing film and a bottom bottle. The bottom bottle is installed at the bottom of the base for storing the lysate; the top opening of the bottom bottle is provided with a sealing film. The piercing sleeve is slidably connected in the base, and the end facing the bottom bottle is provided with a sharp point.

The detachable limit structure is installed between the sampling detection unit and the lysis unit, and is used for limiting the depth of the sampling detection unit inserted into the top opening of the base in the initial state, so as to prevent the piercing sleeve from piercing the sealing film.

In the detection state, the detachable limit structure is removed, and the piercing sleeve pierces the sealing film under the push of the plug-in section of the detection shell; the sample acquisition unit extends into the bottom bottle.

Optionally, the detachable limit structure is a limit pull buckle. The limit pull buckle is arranged at the top opening of the base and integrally formed with the base. A connection between the limit pull buckle and the base is a weak structure breakable by external force. The lateral side of the limit pull buckle facing the base is provided with a transverse limit rib. In the initial state, the transverse limit rib provides limit for the detection shell of the sampling detection unit.

Optionally, the elastic protrusions are fixed on the inner side wall of the base; the piercing sleeve is located between the elastic protrusions and the bottom bottle; a first protrusion and a second protrusion are arranged on the outer side of the plug-in section of the detection shell. The first protrusion and the second protrusion are arranged at intervals along the direction from the plug-in section to the holding section. The positions of the first protrusion and the second protrusion are matched with the elastic protrusions on the inner side wall of the base. In the initial state, the first protrusion on the detection shell passes over the elastic protrusions on the inner wall of the base; in the detection state, the second protrusion on the detection shell passes over the elastic protrusions on the inner wall of the base.

Optionally, the detachable limit structure adopts a protective sleeve. The protective sleeve is sleeved on the plug-in section of the detection shell. In the initial state, the top opening of the base of the lysis unit provides a limit for a step surface on the protective sleeve.

Optionally, the elastic protrusions are fixed on the inner side wall of the base; the piercing sleeve is located between the elastic protrusions and the bottom bottle; the outer side of the plug-in section of the detection shell is provided with the second protrusion. The position of the second protrusion is matched with the elastic protrusions. In the detection state, the second protrusion on the detection shell passes over the elastic protrusions on the inner wall of the base.

Optionally, both sides of the elastic protrusions are provided with guide slopes.

Optionally, the detection shell includes a detection lower plate and a detection upper plate; opposite sides of the detection lower plate and the detection upper plate are fixed together through a plurality of groups of plug-in structures. Both sides of the sample acquisition unit are provided with limit grooves. Two plug-in structures in the opening of the detection shell are respectively clamped into the limit grooves on both sides of the sample acquisition unit.

Optionally, the plug-in structure includes a clamping post and a clamping hole respectively fixed on the detection upper plate and the detection lower plate and are mutually matched.

Optionally, the sample acquisition unit is made of porous mesh fiber and is used for absorbing and conducting liquid specimens.

Optionally, the detection shell is provided with an observation window. A result display area of the detection reagent strip is aligned with an observation window panel. A transparent observation window panel is fixed on the observation window.

Optionally, a sliding resistance is maintained between the piercing sleeve and the base to prevent unintended movement of the piercing sleeve in absence of external thrust force.

Optionally, limit ribs and upper limit step surfaces are used in the base to limit the piercing sleeve.

Optionally, a detection process is as follows:
pulling out the sampling detection unit from the lysis unit, and using the sample acquisition unit of the sampling detection unit to acquire the liquid specimen to be detected;
removing the detachable limit structure, inserting the sampling detection unit into the lysis unit, pushing inward, driving the piercing sleeve in the lysis unit to slide inward by the sampling detection unit, piercing the sealing film, and extending the sample acquisition unit into the bottom bottle; and
drawing the lysate from the bottom bottle by the sample acquisition unit, flowing the lysate together with the liquid specimen to the detection reagent strip, and detecting the contacted liquid specimen by the detection reagent strip.

The disclosure has the following beneficial effects:

First, the present disclosure integrates the sample acquisition unit and the detection reagent strip into an elongated detection shell. In combination with the lysis unit, through a single downward pressing action, the mixing of the liquid specimen with the lysis solution is achieved, as well as the transfer of the mixed liquid to the detection strip.

Second, the present disclosure employs a capped pen-style structure, eliminating the need for a vial structure for storing the detection strip. By achieving automatic lysis and automatic sample addition, the liquid specimen lysis detection device is further miniaturized, thereby enhancing the degree of miniaturization of the liquid specimen lysis detection device.

Third, in the present disclosure, the piercing sleeve capable of being pushed by the detection shell is provided in the lysis unit, thus overcoming the issue of insufficient strength in the sample acquisition unit to puncture aluminum foil; furthermore, the piercing sleeve is designed to encase the sample acquisition unit, which helps minimize or even prevent the sample acquisition unit from bending or deforming due to external forces during the aluminum foil puncture process. This design also prevents the liquid specimen on the sample acquisition unit from being squeezed out during lysis. In combination with the process of the sample acquisition unit drawing up the lysis solution, the utilization rate of the liquid specimen of the disclosure is greatly improved.

Fourth, the present disclosure utilizes the limit pull buckle or the protective sleeve to prevent over-insertion of the sampling detection unit into the lysis unit in the initial state, thus significantly reducing the risk of damage to the liquid specimen lysis detection device during transportation.

### BRIEF DESCRIPTION OF DRAWINGS

FIG. 1 is a schematic diagram of the overall structure of Embodiment 1 according to the present disclosure.

FIG. 2 is an explosion schematic diagram of Embodiment 1 according to the present disclosure.

FIG. 3 is a schematic diagram of the relative positions of the sample acquisition unit and the detection reagent strip in Embodiment 1 according to the present disclosure.

FIG. 4 is a schematic diagram of the lysis unit before and after removing the limit pull buckle in Embodiment 1 according to the present disclosure.

FIG. 5 is a schematic sectional view of the lysis unit in Embodiment 1 according to the present disclosure.

FIG. 6 is a schematic sectional view of the sampling detection unit in Embodiment 1 according to the present disclosure.

FIG. 7 is a schematic diagram of the detection process in Embodiment 1 according to the present disclosure.

FIG. 8 is a schematic diagram of the overall structure of Embodiment 2 according to the present disclosure.

FIG. 9 is an explosion schematic diagram of Embodiment 2 according to the present disclosure.

FIG. 10 is an explosion schematic diagram of Embodiment 3 according to the present disclosure.

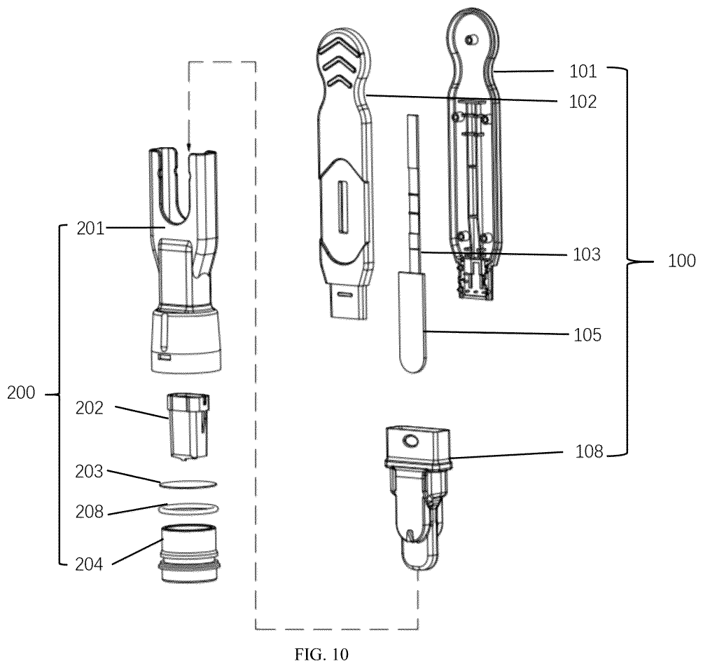

FIG. 11 is a schematic structural diagram of the sampling detection unit in Embodiment 3 according to the disclosure.

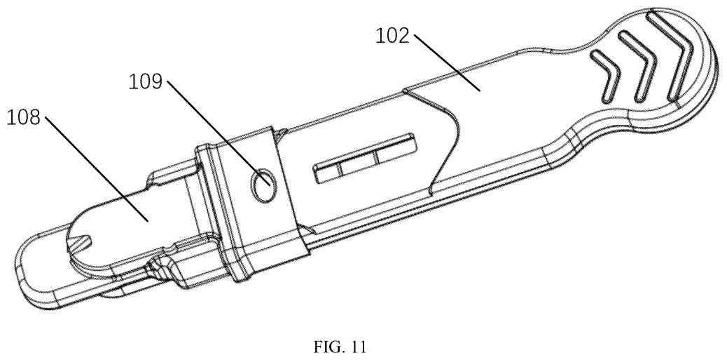

FIG. 12 is a schematic structural diagram of the piercing sleeve in Embodiment 3 according to the present disclosure.

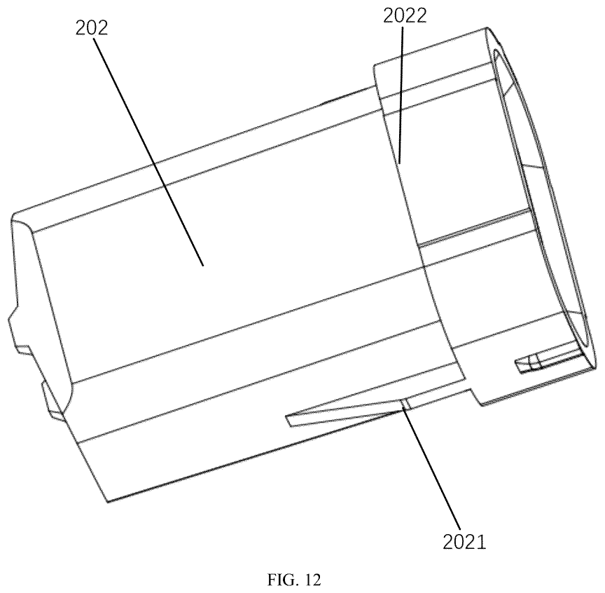

FIG. 13 is a schematic structural diagram of the base in Embodiment 3 according to the present disclosure.

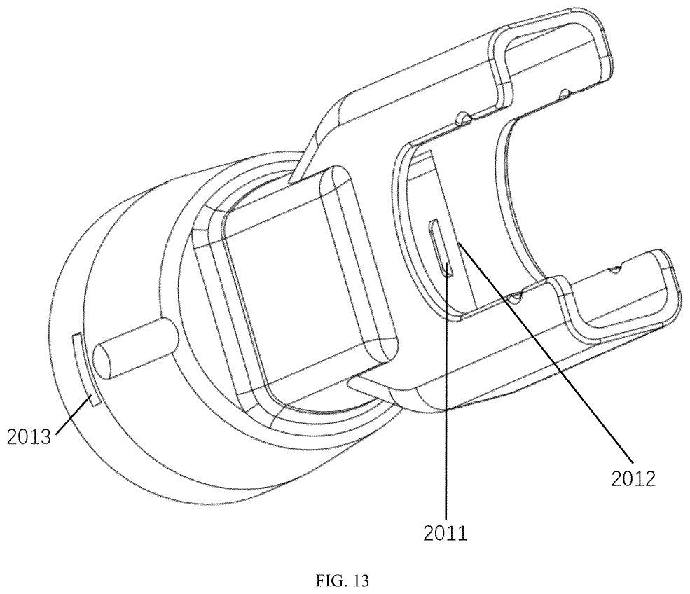

FIG. 14 is a schematic structural diagram of the bottom bottle with sealing film installed in Embodiment 3 according to the present disclosure.

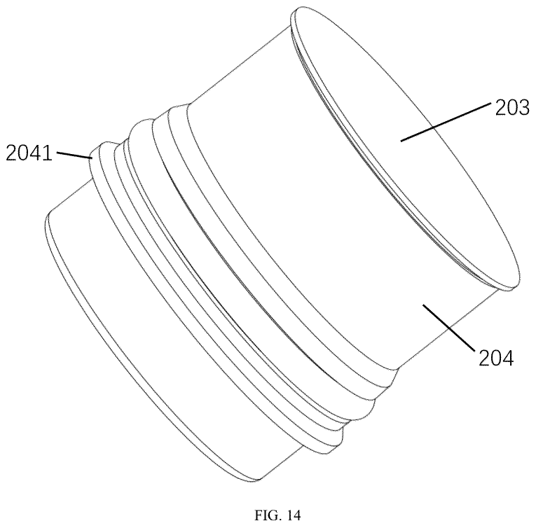

### DESCRIPTION OF EMBODIMENTS

The disclosure is further explained with the attached drawings.

### Embodiment 1

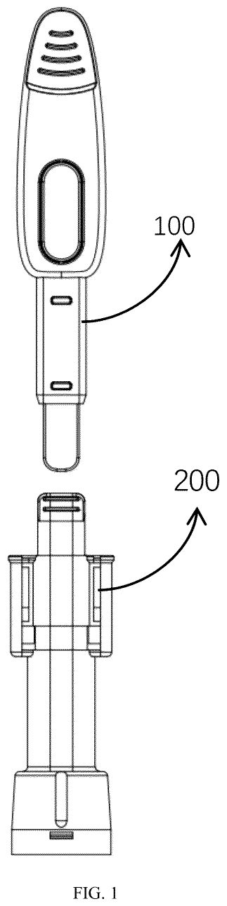

As shown in FIG. 1, a liquid specimen lysis detection device, includes a sampling detection unit 100 and a lysis unit 200.

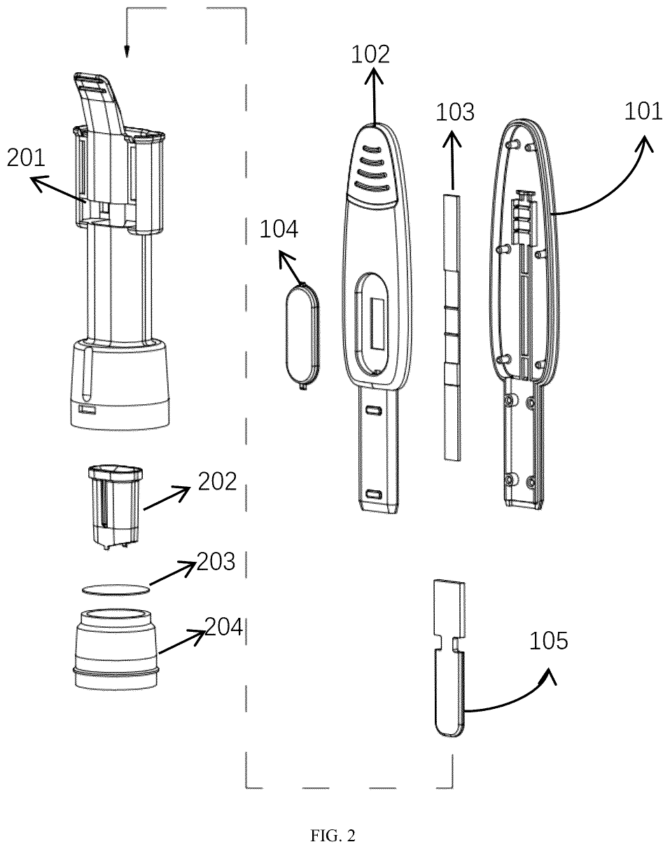

As shown in FIG. 2, the sampling detection unit 100 includes a sample acquisition unit 105, a detection lower plate 101, a detection upper plate 102, a detection reagent strip 103 and an observation window panel 104. The opposite sides of the detection lower plate 101 and the detection upper plate 102 are fixed together through a plurality of groups of plug-in structures to form a detection shell. The plug-in structure includes a clamping post fixed to the detection upper plate 102 and a clamping hole fixed on the detection lower plate 101, the clamping post is detachably engageable with the clamping hole.

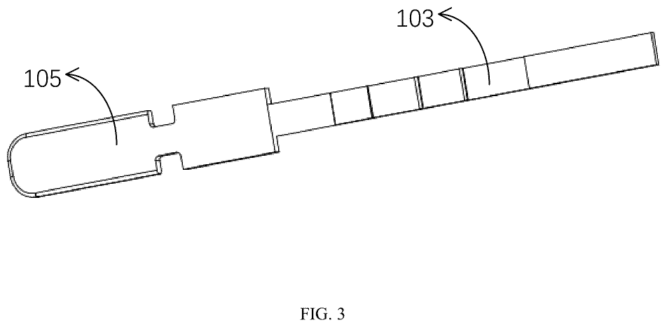

As shown in FIG. 2 and FIG. 3, the bottom of the detection shell is provided with an opening. The sample acquisition unit 105 is fixed at the opening of the detection shell. The inner end of the sample acquisition unit 105 overlaps with the sample loading zone of the detection reagent strip 103, so that the sample is capable of being transmitted to the detection reagent strip through the sampling detection unit. The outer end of the sample acquisition unit 105 protrudes to the area outside the detection shell. Both sides of the sample acquisition unit 105 are provided with limit grooves. Two symmetrical plug-in structures in the opening of the detection shell are respectively clamped into the limit grooves on both sides of the sample acquisition unit 105, so as to realize the fixation between the sample acquisition unit 105 and the detection shell.

The sample acquisition unit 105 is made of porous mesh fiber and is used for absorbing and conducting liquid specimens. In this embodiment, the sample acquisition unit 105 is capable of collecting oral saliva and samples of oral gum residues. The observation window panel 104 is made of transparent material; the detection upper plate 102 is provided with an observation window. An observation window panel 104 is fixed on the observation window. The detection reagent strip 103 is fixed in the detection shell, and the result display area of the detection reagent strip 103 is aligned with the observation window panel 104.

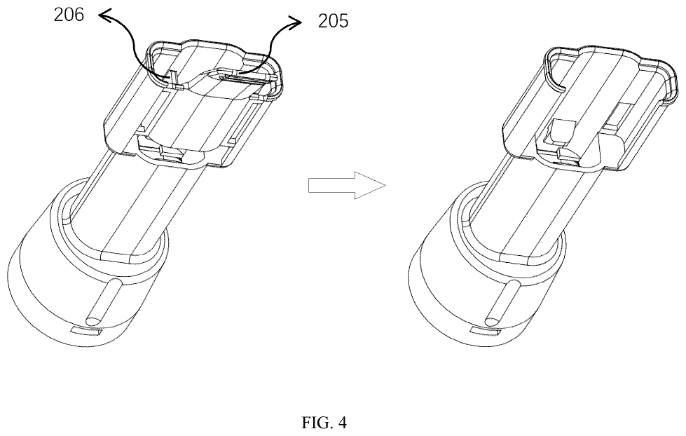

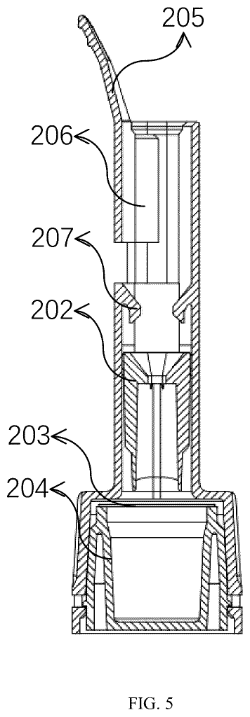

As shown in FIG. 4 and FIG. 5, the lysis unit 200 includes a base 201, a piercing sleeve 202, a sealing film 203, a bottom bottle 204 and a limit pull buckle 205. The base 201 is hollow, and the top and bottom are both open. The bottom bottle 204 is installed at the bottom of the inner cavity of the base 201. The bottom bottle 204 is provided with a lysis solution storage cavity for lysis solution; the top opening of the bottom bottle 204 is provided with a sealing film 203 for sealing the inner cavity of the bottom bottle 204. The piercing sleeve 202 is installed in the middle of the inner cavity of the base 201 for sliding downward to pierce the sealing film 203. The sealing film 203 is made of aluminum foil.

As shown in FIG. 4, the limit pull buckle 205 is arranged at the top opening of the base 201 and integrally formed with the base 201. A connection between the limit pull buckle 205 and the base 201 is a weak structure (the strength is lower than that of the base 201 and other areas of the limit pull buckle 205), and is breakable by external force. The lateral side of the limit pull buckle 205 facing the base 201 is provided with a transverse limit rib 206. The transverse limit rib 206 is used to limit the movement of the sampling detection unit 100 into the lysis unit 200.

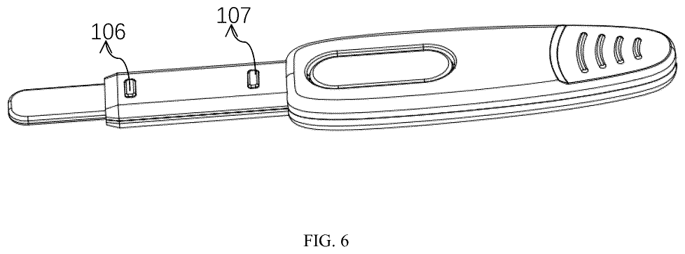

As shown in FIG. 5 and FIG. 6, elastic protrusions 207 are fixed on two opposite side walls of the inner cavity of the base 201; the detection shell composed of the detection lower plate 101 and the detection upper plate 102 is divided into a holding section and a plug-in section. The opening of the detection shell is located at the end of the plug-in section. A first protrusion 106 and a second protrusion 107 are provided on both outer sides of the plug-in section of the detection shell. The first protrusion 106 and the second protrusion 107 are arranged at intervals along the direction from the inserting section to the holding section. The positions of the first protrusion 106 and the second protrusion 107 are matched with the elastic protrusions 207 on the inner side wall of the base.

The elastic protrusions 207 are capable of being deformed under compression. Both sides of the elastic protrusions 207 are provided with guide slopes, enabling the elastic protrusions 207 to not only restrain the first protrusion 106 and the second protrusion 107, but also to allow the first protrusion 106 and the second protrusion 107 to pass over the elastic protrusions 207 when the user pushes or pulls the sampling detection unit 100. The first protrusion 106 and the second protrusion 107 cooperate with the elastic protrusions 207 to define the relative positions between the sampling detection unit 100 and the lysis unit 200 in two relative states.

The piercing sleeve 202 is slidably connected in the base 201 and located between the elastic protrusions 207 and the bottom bottle 204. A sliding resistance is maintained between the piercing sleeve 202 and the base 201 to prevent unintended movement of the piercing sleeve 202 in absence of external thrust force. The piercing sleeve 202 is hollow, and the sample acquisition unit 105 passes through the piercing sleeve 202. The end of the piercing sleeve 202 facing the bottom bottle 204 is provided with a sharp point capable of piercing the sealing film 203.

The two relative states of the sampling detection unit 100 and the lysis unit 200 are the initial state and the detection state respectively. In the initial state, the plug-in section of the detection shell extends into the top opening of the base 201, and the end of the plug-in section contacts with the end of the piercing sleeve 202. The joint between the plug-in section and the holding section of the detection shell is limited by the limit pull buckle 205; the first protrusion 106 on the detection shell passes over the elastic protrusions 207 on the inner wall of the base. At this point, the elastic protrusions 207 on the inner wall of the base is capable of restricting the outward movement of the first protrusion 106 of the sampling detection unit.

In the detection state, the limit pull buckle 205 is pulled off, the second protrusion 107 on the detection shell passes over the elastic protrusions 207 on the inner wall of the base; the piercing sleeve 202 pierces the sealing film 203, and the sample acquisition unit 105 extends into the bottom bottle 204. At this time, the sampling detection unit is permitted to continue to move to the lysis unit, and the elastic protrusions 207 on the inner wall of the base is capable of restricting the second protrusion 107 of the sampling detection unit from moving outward.

An application method of the liquid specimen lysis detection device is as follows:

Step 1. pulling out the sampling detection unit 100 from the lysis unit 200, and using the sample acquisition unit 105 of the sampling detection unit 100 to acquire the liquid specimen to be detected;

Step 2: pulling off the joint between the limit pull buckle 205 on the lysis unit 200 and the base 201, and removing the limit pull buckle 205;

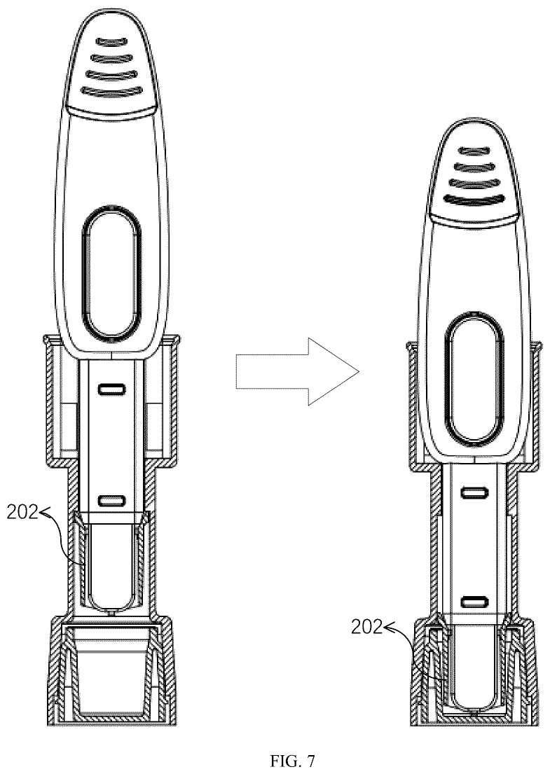

Step 3, vertically placing the lysis unit 200 as shown in FIG. 7; reinserting the sampling detection unit 100 into the lysis unit 200 and pushing inward, causing the second protrusion 107 on the detection shell to pass over the elastic protrusions 207 on the inner wall of the base 201. Piercing the sealing film 203 by the piercing sleeve 202 under the push of the plug-in section of the detection shell, and extending the sample acquisition unit 105 into the bottom bottle 204;

step 4, drawing the lysate from the bottom bottle 204 by the sample acquisition unit 105, flowing the lysate to the sample loading zone of the detection reagent strip 103 together with the liquid specimen; and

step 5, observing the detection results through the observation window panel 104 after waiting for the reaction of the detection reagent strip 103 for a preset period of time.

### Embodiment 2

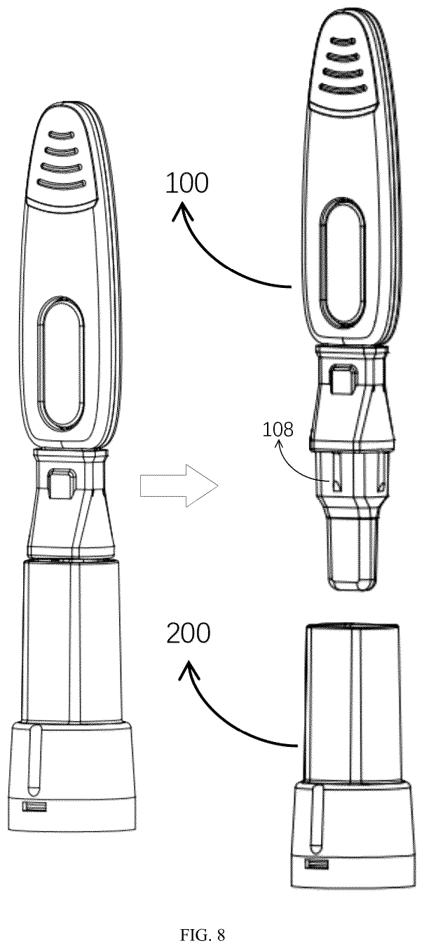

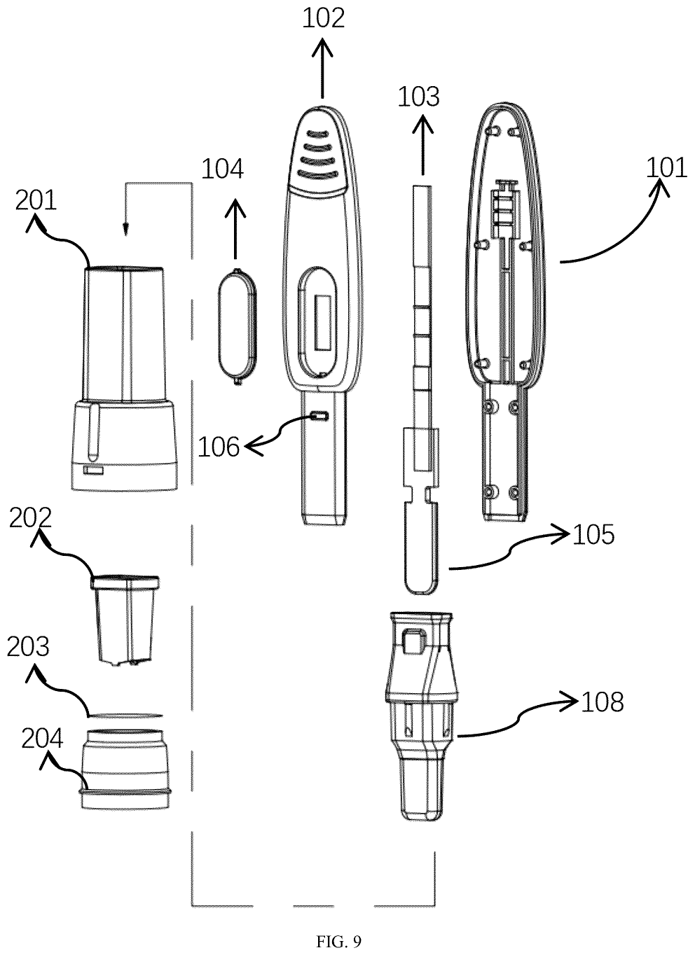

As shown in FIG. 8 and FIG. 9, a liquid specimen lysis detection device is provided, where the difference between this embodiment and Embodiment 1 lies in:

1) the plug-in section of the detection shell is not provided with the first protrusion 106; the sampling detection unit further includes a protective sleeve 108. The protective sleeve 108 is sleeved on the outer side of the plug-in section of the detection shell and is limited by the second protrusion 107. The protective sleeve 108 is used to protect the sample acquisition unit. The liquid specimen lysis detection device provided by this embodiment pulls out the protective sleeve 108 before collecting the liquid specimen to be detected.

2) The lysis unit 200 is not provided with a limit pull buckle 205; in the initial state, the step surface on the protective sleeve 108 is limited from the end surface of the top opening of the base 201 of the lysis unit, so as to avoid over-insertion of the sampling detection unit 100 into the lysis unit 200 and puncture of the sealing film 203 by the piercing sleeve 202.

An application method of the liquid specimen lysis detection device is as follows:
step 1, pulling out the sampling detection unit 100 from the lysis unit 200, and taking off the protective sleeve 108, and then using the sample acquisition unit 105 of the sampling detection unit 100 to acquire the liquid specimen to be detected;
step 2, vertically placing the lysis unit 200; reinserting the sampling detection unit 100 without the protective sleeve 108 into the lysis unit 200 and pushing inward, causing the second protrusion 107 on the detection shell to pass over the elastic protrusions 207 on the inner wall of the base 201. Piercing the sealing film 203 by the piercing sleeve 202 under the push of the plug-in section of the detection shell, and extending the sample acquisition unit 105 into the bottom bottle 204;

1step 3, drawing the lysate from the bottom bottle 204 by the sample acquisition unit 105, flowing the lysate to the sample loading zone of the detection reagent strip 103 together with the liquid specimen; and
step 4, observing the detection results through the observation window panel 104 after waiting for the reaction of the detection reagent strip 103 for a preset period of time.

### Embodiment 3

A liquid specimen lysis detection device is provided, where the difference between this embodiment and Embodiment 1 lies in the structures of the sampling detection unit 100 and the lysis unit 200.

In this embodiment, the sampling detection unit 100 includes a sample acquisition unit 105, a detection lower plate 101, a detection upper plate 102, a detection reagent strip 103, an observation window panel 104, and a protective sleeve 108. The detection shell composed of the detection lower plate 101 and the detection upper plate 102, is not provided with the first protrusion 106 or the second protrusion 107 for engagement with the base 201. The plug-in section of the detection shell is inserted and matched with the top opening of the protective sleeve 108, allowing the protective sleeve 108 to sleeve outside the sample acquisition unit 105, which plays a protective role and reduces the risk of pollution of the sample acquisition unit 105. The protective sleeve 108 and the detection shell are axially limited by mutually matched limit surfaces, and are detachably fixed by a buckle structure 109. The buckle structure 109 includes a protruding fastening point on the detection shell and a locking groove 2013 on the detection shell.

In this embodiment, the lysis unit 200 includes a base 201, a piercing sleeve 202, a sealing film 203, a bottom bottle 204, and a sealing ring 208, excluding the limit pull buckle 205. There are no elastic protrusions 207 in the base 201. The outer bottom of the protective sleeve 108 is inserted and matched with the top opening of the base 201; the protective sleeve 108 and the detection shell are axially limited by the limit protrusions on the protective sleeve 108 and the limit grooves on the detection shell, and are detachably fixed by the buckle structure 109. The piercing sleeve 202 is located between the sealing film 203 and the protective sleeve 108. When the protective sleeve 108 is sleeved on the detection shell, the detection shell cannot push the piercing sleeve 202 to pierce the sealing film 203 downward.

The outer side of the piercing sleeve 202 is provided with a guide rib 2021 and a limit boss 2022. The guide rib (2021) is in sliding fit with the guide groove of the inner cavity of the base 201; the middle part of the inner cavity of the base 201 is provided with a lower limit rib 2011 and an upper limit step surface 2012; the limit boss 2022 is located between the lower limit rib 2011 and the upper limit step surface 2012. The upper limit step surface 2012 is used to prevent the limit boss 2022 from moving towards the sampling detection unit 100. The lower limit rib 2011 is used to prevent the limit boss 2022 from moving towards the sealing film 203. The limit boss 2022 of the piercing sleeve 202 is capable of passing over the lower limit rib 2011 through deformation under the action of external thrust force.

The outer side wall of the bottom bottle 204 is provided with an annular groove and a locking rib 2041; the sealing ring 208 is arranged on the annular groove and located between the bottom bottle 204 and the inner wall of the base 201, and plays a sealing role. The bottom of the inner cavity of the base 201 is provided with a locking groove 2013; the locking rib 2041 of the bottom bottle 204 is engaged with the locking groove 2013 of the base 201 to fix the bottom bottle 204 and the base 201. The sealing ring 208 is located between the locking rib 2041 and the top opening of the bottom bottle 204.

The working process of this embodiment is the same as the working process of Embodiment 2.

What is claimed is:

1. A liquid specimen lysis detection device, comprising a sampling detection unit (100), a lysis unit (200) and a detachable limit structure, wherein the sampling detection unit (100) comprises a detection shell, a sample acquisition unit (105) and a detection reagent strip (103); the detection reagent strip (103) is installed on the detection shell; the detection shell is divided into a holding section and a plug-in section; the end of the plug-in section is provided with an opening; the sample acquisition unit (105) is fixed at the opening of the detection shell; the sample acquisition unit (105) is in contact with the sample loading zone of the detection reagent strip (103);
the lysis unit (200) comprises a base (201), a piercing sleeve (202), a sealing film (203) and a bottom bottle (204); the bottom bottle (204) is installed at the bottom of the base (201) for storing the lysate; the top opening of the bottom bottle (204) is provided with a sealing film (203); the piercing sleeve (202) is slidably connected in the base (201), and the end facing the bottom bottle (204) is provided with a sharp point;
the detachable limit structure is installed between the sampling detection unit (100) and the lysis unit (200) for limiting the depth of the sampling detection unit (100) inserted into the top opening of the base (201) in the initial state, and preventing the piercing sleeve (202) from puncturing the sealing film (203);
in the detection state, the detachable limit structure is removed, and the piercing sleeve (202) pierces the sealing film (203) under the push of the plug-in section of the detection shell; the sample acquisition unit (105) extends into the bottom bottle (204).

2. The liquid specimen lysis detection device according to claim 1, wherein the detachable limit structure is a limiting pull button (205); the limit pull buckle (205) is arranged at the top opening of the base (201) and integrally formed with the base (201); a connection between the limit pull buckle (205) and the base (201) is a weak structure breakable by external force; the lateral side of the limit pull buckle (205) facing the base (201) is provided with a transverse limit rib (206); in the initial state, the transverse limit rib (206) provides limit for the detection shell of the sampling detection unit (100).

3. The liquid specimen lysis detection device according to claim 2, wherein elastic protrusions (207) are fixed on the inner side wall of the base (201); the piercing sleeve (202) is located between the elastic protrusions (207) and the bottom bottle (204); a first protrusion (106) and a second protrusion (107) are arranged on the outer side surface of the plug-in section of the detection shell; the first protrusion (106) and the second protrusion (107) are arranged at intervals along the direction from the plug-in section to the holding section; the positions of the first protrusion (106) and the second protrusion (107) are matched with the elastic protrusions (207) on the inner side wall of the base; in the initial state, the first protrusion (106) on the detection shell passes over the elastic protrusions (207) on the inner wall of the base; in the detection state, the second protrusion (107) on the detection shell passes over the elastic protrusions (207) on the inner wall of the base.

4. The liquid specimen lysis detection device according to claim 1, wherein the detachable limit structure adopts a protective sleeve (108); the protective sleeve (108) is sleeved on the plug-in section of the detection shell.

5. The liquid specimen lysis detection device according to claim 4, wherein the protective sleeve (108) and the detection shell are detachably fixed by a buckle structure (109).

6. The liquid specimen lysis detection device according to claim 4, wherein in the initial state, the outer bottom of the protective sleeve (108) is inserted and matched with the top opening of the base (201), and is limited by a limit structure; the piercing sleeve (202) is located between the sealing film (203) and the protective sleeve (108).

7. The liquid specimen lysis detection device according to claim 4, wherein the elastic protrusions (207) are fixed on the inner side wall of the base (201); the piercing sleeve (202) is located between the elastic protrusions (207) and the bottom bottle (204); the second protrusion (107) is arranged on the outer side of the plug-in section of the detection shell; the position of the second protrusion (107) is matched with the elastic protrusions (207); in the detection state, the second protrusion (107) on the detection shell passes over the elastic protrusions (207) on the inner wall of the base.

8. The liquid specimen lysis detection device according to claim 3, wherein both sides of the elastic protrusions (207) are provided with guide slopes.

9. The liquid specimen lysis detection device according to claim 1, wherein the detection shell comprises a detection lower plate (101) and a detection upper plate (102); opposite sides of the detection lower plate (101) and the detection upper plate (102) are fixed together through a plurality of groups of plug-in structures; both sides of the sample acquisition unit (105) are provided with limit grooves; two plug-in structures in the opening of the detection shell are respectively clamped into the limit grooves on both sides of the sample acquisition unit (105).

10. The liquid specimen lysis detection device according to claim 9, wherein the plug-in structure comprises a clamping post and a clamping hole respectively fixed on the detection upper plate (102) and the detection lower plate (101) and are mutually matched.

11. The liquid specimen lysis detection device according to claim 1, wherein the sample acquisition unit (105) is made of porous mesh fiber and is used for absorbing and conducting liquid specimens.

12. The liquid specimen lysis detection device according to claim 1, wherein a sliding resistance is maintained between the piercing sleeve (202) and the base (201) to prevent unintended movement of the piercing sleeve (202) in absence of external thrust force.

13. The liquid specimen lysis detection device according to claim 1, wherein a limit boss (2022) is arranged on the outer side of the piercing sleeve (202); the middle part of the inner cavity of the base (201) is provided with a lower limit rib (2011) and an upper limit step surface (2012); the limit boss (2022) is limited between the lower limit rib (2011) and the upper limit step surface (2012); the limit boss (2022) is capable of passing over the lower limit rib (2011) and moves towards the sealing film (203) under external thrust force.

14. The liquid specimen lysis detection device according to claim 1, wherein a sealing ring (208) is arranged between the outer side wall of the bottom bottle (204) and the inner wall of the base (201).

15. The liquid specimen lysis detection device according to claim 1, wherein the outer side wall of the base bottle (204) and the inner cavity of the base (201) are detachably connected via the mutually matched locking rib (2041) and locking groove (2013); the locking rib (2041) of the bottom bottle (204) is in snap fit with the locking groove (2013) of the base (201).

16. The liquid specimen lysis detection device according to claim 1, wherein a detection process is as follows:
pulling out the sampling detection unit (100) from the lysis unit (200), and using the sample acquisition unit (105) of the sampling detection unit (100) to acquire the liquid specimen to be detected;
removing the detachable limit structure, inserting the sampling detection unit (100) into the lysis unit (200), pushing inward, driving the piercing sleeve (202) in the lysis unit (200) to slide inward by the sampling detection unit (100), piercing the sealing film (203), and extending the sample acquisition unit (105) into the bottom bottle (204); and
drawing the lysate from the bottom bottle (204) by the sample acquisition unit (105), flowing the lysate together with the liquid specimen to the detection reagent strip (103), and detecting the contacted liquid specimen by the detection reagent strip (103).
